(19) United States
(12) Patent Application Publication
(10) Pub. No.: US 2026/0073568 A1
(43) Pub. Date: Mar. 12, 2026

(54) END-TO-END LEARNING-BASED POINT CLOUD ATTRIBUTE CODING FRAMEWORK

(71) Applicant: InterDigital VC Holdings, Inc., Wilmington, DE (US)

(72) Inventors: Yuning HUANG, West Lafayette, IN (US); Muhammad Asad LODHI, New York, NY (US); Jiahao PANG, New York, NY (US); Junghyun AHN, New York, NY (US); Dong TIAN, Wilmington, DE (US)

(21) Appl. No.: 18/830,310

(22) Filed: Sep. 10, 2024

(51) Int. Cl. G06T 9/00; G06T 9/40

(52) U.S. Cl. CPC G06T 9/001; G06T 9/40

(57) ABSTRACT

In one implementation, a method of decoding point cloud data is presented, comprising: decoding features representing voxel attributes in an octree structure, wherein a decoded feature for a current voxel is representative of at least a set of voxels that are still to be reconstructed; determining an attribute probability of the current voxel based on the decoded feature for the current voxel; decoding attribute information of voxels in the octree structure, wherein the attribute information for the current voxel is decoded based on the attribute probability for the current voxel; and reconstructing the point cloud based on the attribute information of voxels in the octree structure. On the encoder side, the features are extracted and encoded into the bitstream.

### INCORPORATION BY REFERENCE

The present application incorporates by reference in their entirety the following applications: U.S. patent application Ser. No. 18/679,144, entitled “An End-To-End Learning-Based Point Cloud Coding Framework” ('“144 application”), and U.S. patent applicant Ser. No. 18/654,987, entitled “Rate Control for Point Cloud Coding with a Hyperprior Model” (“'987 application”).

### BACKGROUND

The present application is related to point cloud compression and processing.

The Point Cloud (PC) data format is a universal data format across several business domains, e.g., from autonomous driving, robotics, augmented reality/virtual reality (AR/VR), civil engineering, computer graphics, to the animation/movie industry. 3D LiDAR (Light Detection and Ranging) sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever and is expected to be an ultimate enabler in the applications discussed herein.

### BRIEF SUMMARY

Briefly stated, in one embodiment, a method of decoding point cloud data is presented, comprising: decoding features representing voxel attributes in an octree structure, wherein a decoded feature for a current voxel is representative of at least a set of voxels that are still to be reconstructed; determining an attribute probability of the current voxel based on the decoded feature for the current voxel; decoding attribute information of voxels in the octree structure, wherein the attribute information for the current voxel is decoded based on the attribute probability for the current voxel; and reconstructing the point cloud based on the attribute information of voxels in the octree structure.

According to another embodiment, an apparatus for decoding point cloud data is presented, comprising one or more processors and at least one memory coupled to the one or more processors, wherein the one or more processors are configured to: decode features representing voxel attributes in an octree structure, wherein a decoded feature for a current voxel is representative of at least a set of voxels that are still to be reconstructed; determine an attribute probability of the current voxel based on the decoded feature for the current voxel; decode attribute information of voxels in the octree structure, wherein the attribute information for the current voxel is decoded based on the attribute probability for the current voxel; and reconstruct the point cloud based on the attribute information of voxels in the octree structure.

In one embodiment, the set of voxels includes one or more voxels in a child level of the current voxel in the octree structure.

In one embodiment, the set of voxels only includes one or more voxels in a same level as the current voxel in the octree structure.

In one embodiment, the decoder further obtains another feature for the current voxel from one or more coarser levels; and generates a first feature based on the another feature and the decoded feature of the current voxel, wherein the attribute information of the current voxel is decoded based on the first feature.

In one embodiment, the decoder generates the first feature by concatenating the another feature and the decoded feature of the current voxel and applying a plurality of convolutional layers to the concatenated features to form the first feature.

In one embodiment, the decoder obtains hyperprior parameters of the features in a current level of the octree structure based on one or more coarser levels, wherein the features of the current level are decoded based on the hyperprior parameters.

In one embodiment, the decoder obtains hyperprior parameters by performing: obtaining a second feature from the one or more coarser levels; obtaining a third feature at a resolution of the current level, using at least a neural network with upsampling; obtaining an initial set of hyperprior parameters based on the third feature using at least another neural network; obtaining voxel occupancy information at the current level; and pruning any hyperprior parameters at empty voxels indicated by the voxel occupancy information to form the hyperprior parameters.

In one embodiment, the second feature is obtained from the previous level only.

In one embodiment, the decoder further augments the feature based on a parameter controlling a tradeoff between a bit rate and quality.

According to another embodiment, a method of encoding point cloud data is presented, comprising: obtaining features representing voxel attributes in an octree structure, wherein feature for a current voxel is representative of at least a set of voxels that are still to be encoded; encoding the feature; determining an attribute probability of the current voxel based on the feature; and encoding attribute information of voxels in the octree structure, wherein the attribute information for the current voxel is encoded based on the attribute probability for the current voxel.

In one embodiment, the set of voxels includes one or more voxels in a child level of the current voxel in the octree structure.

In one embodiment, the set of voxels only includes one or more voxels in a same level as the current voxel in the octree structure.

In one embodiment, the encoder obtains another feature for the current voxel from one or more coarser levels; and generates a first feature based on the another feature and the feature of the current voxel, wherein the attribute information of the current voxel is encoded based on the first feature.

In one embodiment, the encoder generates the first feature by concatenating the another feature and the feature of the current voxel and applying a plurality of convolutional layers to the concatenated feature.

In one embodiment, the encoder further obtains hyperprior parameters of the features in a current level of the octree structure based on one or more coarser levels, wherein the features of the current voxel are encoded based on the hyperprior parameters.

In one embodiment, the encoder obtains the hyperprior parameters by obtaining a second feature from the one or more coarser levels; obtaining a third feature at a resolution of the current level, using at least a neural network with upsampling; obtaining an initial set of hyperprior parameters based on the third feature using at least another neural network; obtaining voxel occupancy information at the current level; and pruning any hyperprior parameters at empty voxels indicated by the voxel occupancy information to form the hyperprior parameters.

In one embodiment, the second feature is obtained from the previous level only.

In one embodiment, the encoder further augments the feature based on a parameter controlling a tradeoff between a bit rate and quality.

According to another embodiment, a method of decoding point cloud data is presented, wherein a coarser portion of the point cloud data is decoded losslessly and a finer portion is decoded by lossy compression, the lossy compression comprising: decoding first attribute information for the finer portion; upsampling second attribute information from the coarser portion; and generating third attribute information for the finer portion based on the first attribute information and the upsampled attribute information.

According to another embodiment, an apparatus for decoding point cloud data is presented, wherein a coarser portion of the point cloud data is decoded losslessly and a finer portion is decoded by lossy compression, comprising one or more processors and at least one memory coupled to the one or more processors, wherein the one or more processors are configured to perform the lossy compression by: decoding first attribute information for the finer portion; upsampling second attribute information from the coarser portion; and generating third attribute information for the finer portion based on the first attribute information and the upsampled attribute information.

In one embodiment, the first attribute information includes a difference feature indicating a difference between the upsampled reconstruction of the previous level and the current level of the point cloud, wherein a convolutional layer is applied to the difference feature, and the second attribute information includes a reconstruction of a previous level of the point cloud.

In one embodiment, the decoder further upsamples a reconstruction of a previous level of the point cloud, wherein convolutional layers are applied to the upsampled reconstruction of the previous level.

In one embodiment, the lossy compression comprises convolution-based feature aggregation.

In one embodiment, the lossy compression comprises feature aggregation based on point-based networks.

In one embodiment, the feature-based attribute coding pipeline and the octree-based attribute coding pipeline share a same backbone architecture to decode features.

In one embodiment, a plurality of neural networks are used in decoding the coarser portion and the finer portion of the point cloud, wherein the plurality of neural networks share same network architecture and network parameters.

According to another embodiment, a method of encoding point cloud data is presented, wherein a coarser portion of the point cloud data is encoded losslessly and a finer portion is encoded by lossy compression, the lossy compression, comprising: reconstructing the coarser portion of the point cloud; obtaining point cloud at a current level; and encoding features for the finer portion based on the point cloud at the current level and feature information from the coarser portion.

According to another embodiment, an apparatus for encoding point cloud data is presented, wherein a coarser portion of the point cloud data is encoded losslessly and a finer portion is encoded by lossy compression, comprising one or more processors and at least one memory coupled to the one or more processors, wherein the one or more processors are configured to perform the lossy compression by: reconstructing the coarser portion of the point cloud; obtaining point cloud at a current level; and encoding features for the finer portion based on the point cloud at the current level and feature information from the coarser portion.

In one embodiment, the encoder upsamples a reconstruction of a previous level of the point cloud; obtains a difference between the upsampled reconstruction of the previous level and the current level of the point cloud; and generates a difference feature indicating the difference using a neural network, wherein the difference feature is encoded.

In one embodiment, the encoder generates a first set of features representing voxel attributes in an octree structure, based on the point cloud at the current level; upsamples a reconstruction of a previous level of the point cloud; generates a second set of features based on the upsampled reconstruction; and encodes the first set of features based on the second set of features.

In one embodiment, the lossy compression comprises convolution-based feature aggregation.

In one embodiment, the lossy compression comprises feature aggregation based on point-based networks.

In one embodiment, the lossy compression is based on a feature-based attribute coding pipeline and the lossless compression is based on an octree-based attribute coding pipeline, and wherein the feature-based attribute coding pipeline and the octree-based attribute coding pipeline share a same backbone to encode features.

In one embodiment, a plurality of neural networks are used in encoding the coarser portion and the finer portion of the point cloud, and wherein the plurality of neural networks share same network architecture and network parameters.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1 illustrates a block diagram of a system within which aspects of the present embodiments may be implemented;

FIG. 2 illustrates voxels in different levels;

FIG. 3 illustrates learned octree-based attribute encoding;

FIG. 4 illustrates learned octree-based attribute decoding;

FIG. 5 illustrates voxels in different levels;

FIG. 6 illustrates octree-based attribute encoding using a learning-based method, according to an embodiment;

FIG. 7 illustrates a feature aggregator (FA) with only one level as input, according to an embodiment;

FIG. 8 illustrates a feature aggregator (FA) with aggregated feature as input, according to an embodiment;

FIG. 9 illustrates a feature encoder using uniform quantization, according to an embodiment;

FIG. 10 illustrates a feature encoder using hyperprior encoder, according to an embodiment;

FIG. 11 illustrates an attribute probability estimator (in encoder and decoder), according to an embodiment;

FIG. 12 illustrates octree-based attribute decoding using a learning-based method, according to an embodiment;

FIG. 13 illustrates a feature decoder with de-quantization, according to an embodiment;

FIG. 14 illustrates a feature decoder using hyperprior decoder, according to an embodiment;

FIG. 15 illustrates a traditional octree-based attribute coding in a larger codec system;

FIG. 16 illustrates an attribute encoder (AtE), according to an embodiment;

FIG. 17 illustrates an attribute decoder (AtD), according to an embodiment;

FIG. 18 illustrates octree-based attribute coding in a larger codec system, according to an embodiment;

FIG. 19 illustrates octree-based attribute coding in a larger codec system, according to another embodiment;

FIG. 20A illustrates octree-based attribute coding in a larger codec system and FIG. 20B illustrates an FF module, according to another embodiment;

FIG. 21A illustrates octree-based attribute coding in a larger codec system and FIG. 21B illustrates an HS module, according to an embodiment;

FIG. 22 illustrates point-based feature coding in a larger codec system, according to an embodiment;

FIG. 23A and FIG. 23B illustrate an end-to-end learning-based point cloud attribute compression framework, according to an embodiment;

FIG. 24 illustrates a feature encoder using conditional encoding, according to an embodiment;

FIG. 25 illustrates a feature decoder using conditional decoding, according to an embodiment;

FIG. 26 illustrates a conditional encoder/decoder, according to an embodiment;

FIG. 27A illustrates a feature-based point cloud attribute compression within an end-to-end compression framework, FIG. 27B illustrates a feature encoder using conditional encoding, and FIG. 27C illustrates a feature decoder using conditional decoding, according to an embodiment;

FIG. 28 illustrates an adaptive affine (AA) module with Style Encoding (SE), according to an embodiment; and

FIG. 29 illustrates an augmented FA module with an AA module inside it, according to an embodiment.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

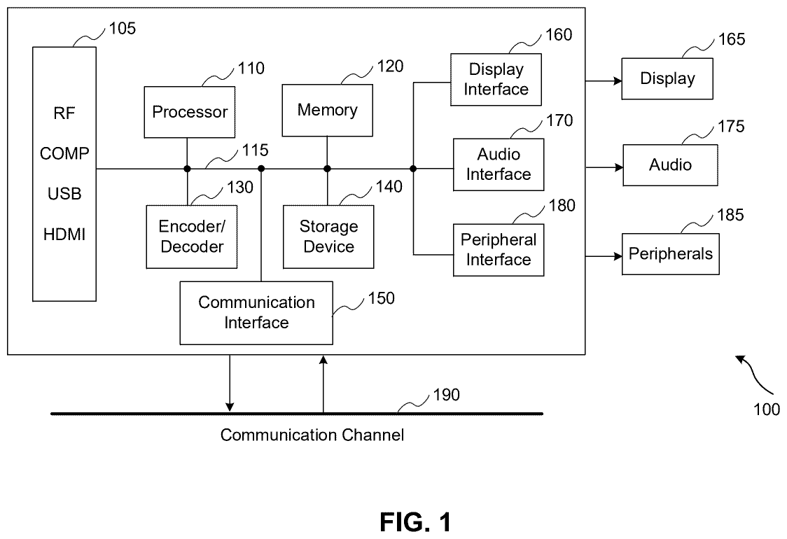

Referring to the drawings, there is shown in FIG. 1 a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, JPEG Pleno, MPEG-I, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

### Point Cloud Data Format

Point cloud data is believed to consume a large portion of network traffic, e.g., among connected cars over 5G network, and immersive communications (VR/AR). Efficient representation formats are necessary for point cloud understanding and communication. In particular, raw point cloud data needs to be properly organized and processed for the purposes of world modeling and sensing. Compression on raw point clouds is essential when storage and transmission of the data are required in the related scenarios.

Furthermore, point clouds may represent a sequential scan of the same scene, which contains multiple moving objects. They are called dynamic point clouds as compared to static point clouds captured from a static scene or static objects. Dynamic point clouds are typically organized into frames, with different frames being captured at different times. Dynamic point clouds may require the processing and compression to be in real-time or with low delay.

Each point of the point clouds is represented at least by a 3D position (x, y, z) . The set of the 3D positions illustrates the geometry of the object/scene that the point cloud is captured from. Additionally, each point of the point cloud can be associated with some attributes, depending on the applications. For example, for VR/AR/Gaming, the attribute includes color (r, g, b); and for LiDAR, the attribute includes reflectance.

### Point Cloud Data Use Cases

The automotive industry and autonomous car are domains in which point clouds may be used. Autonomous cars should be able to “probe” their environment to make good driving decisions based on the reality of their immediate surroundings. Typical sensors like LiDARs produce (dynamic) point clouds that are used by the perception engine. These point clouds are not intended to be viewed by human eyes and they are typically sparse, not necessarily colored, and dynamic with a high frequency of capture. They may have other attributes like the reflectance ratio provided by the LiDAR as this attribute is indicative of the material of the sensed object and may help in making a decision.

Virtual Reality (VR) and immersive worlds have become a hot topic and foreseen by many as the future of 2D flat video. The basic idea is to immerse the viewer in an environment all around the viewer, as opposed to standard TV where the viewer can only look at the virtual world in front of the viewer. There are several gradations in the immersivity depending on the freedom of the viewer in the environment. Point cloud is a good format candidate to distribute VR worlds. They may be static or dynamic and are typically of average size, for example, no more than millions of points at a time.

Point clouds may also be used for various purposes such as culture heritage/buildings in which objects like statues or buildings are scanned in 3D to share the spatial configuration of the object without sending or visiting it. Also, it is a way to ensure preserving the knowledge of the object in case it may be destroyed, for instance, a temple by an earthquake. Such point clouds are typically static, colored, and huge.

Another use case is in topography and cartography in which using 3D representations, maps are not limited to the plane and may include the relief. Google Maps is now a good example of 3D maps but uses meshes instead of point clouds. Nevertheless, point clouds may be a suitable data format for 3D maps and such point clouds are typically static, colored, and huge.

World modeling and sensing via point clouds could be an essential technology to allow machines to gain knowledge about the 3D world around them, which is crucial for the applications discussed above.

3D point cloud data are essentially discrete samples on the surfaces of objects or scenes. To fully represent the real world with point samples, in practice it requires a huge number of points. For instance, a typical VR immersive scene contains millions of points, while point clouds typically contain hundreds of millions of points. Therefore, the processing of such large-scale point clouds is computationally expensive, especially for consumer devices, e.g., smartphone, tablet, and automotive navigation system, that have limited computational power.

The first step for any processing or inference on the point cloud is to have efficient storage methodologies. To store and process the input point cloud with affordable computational cost, one solution is to down-sample it first, where the down-sampled point cloud summarizes the geometry of the input point cloud while having much fewer points. The down-sampled point cloud is then fed to the subsequent machine task for further consumption. However, further reduction in storage space can be achieved by converting the raw point cloud data (original or down sampled) into a bitstream through entropy coding techniques for lossless compression.

In addition to lossless coding, many scenarios seek lossy coding for a significantly improved compression ratio while maintaining the induced distortion under certain quality levels. To achieve a less lossy coding, an efficient point feature extractor is necessary to improve the accuracy of the reconstruction within the given resource budget.

### Learning-Based Point Cloud Compression

Since point cloud data is composed of two components: geometry information and attribute information, the compression of point clouds can be classified into two categories: geometry coding and attribute coding. This work is focused on attribute coding and assumes that the geometry information of the point cloud is already coded and available at both encoder and decoder.

Examples of existing learning-based point cloud attribute compression techniques include deep octree-based attribute compression and end-to-end feature-based attribute coding. With deep octree-based attribute compression, neural network-based models are utilized to estimate the discrete probability distribution of the attribute values. Such estimated probabilities are then used to help the arithmetic coder to encode or decode the attribute value(s) associated with that particular point.

The main challenge when using a learning-based method for octree-based attribute coding is on how to effectively estimate the attribute probability distribution. With higher accuracy of the estimated distribution, the arithmetic coding of the attribute of an octree voxel would use fewer bits. In traditional learning-based methods for octree-based attribute methods, neural network models are typically provided with an input based on the attributes at the parent octree level or the derived features from parent octree level. They may additionally use the attribute information and derived features from sibling octree voxels that are already encoded or decoded. Because there is no access to finer octree level information, such approaches may suffer from less accurate probability estimation and non-necessary high complexity may be also involved.

To the best of our knowledge, all previous learning-based methods for octree-based attribute coding depend solely on octree voxel attribute information from parent levels, or from sibling nodes at current level. This constitutes a top-down strategy.

With such previous learning-based methods, the encoder and decoder both conduct the probability estimation procedure using exactly the same method that can be non-learning-based. The only interface between their encoder and decoder is the arithmetic coded attribute information.

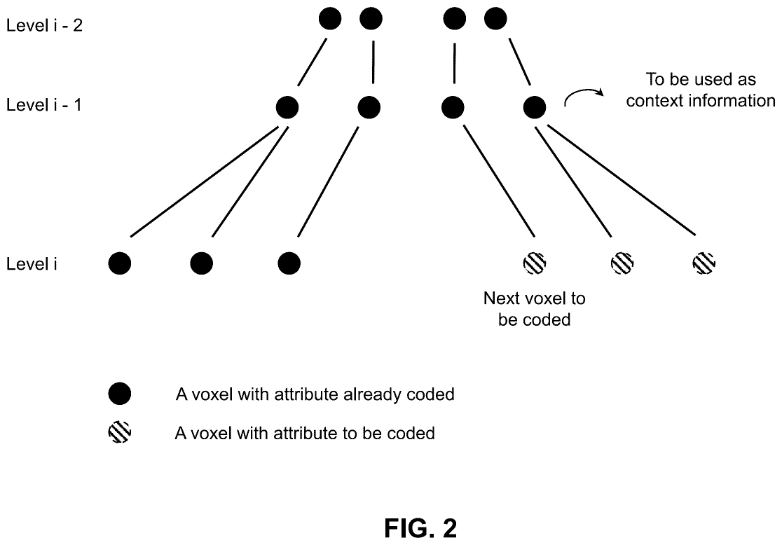

FIG. 2 illustrates a portion (level i−2, i−1, i) of an octree to be coded. In FIG. 2, we use a binary tree representing an octree for a point cloud only for the purpose of simplifying the drawing. A solid point represents an occupied octree voxel with attributes, that have been already encoded or decoded, while a circle with shading represents the octree voxels with attributes to be encoded or decoded.

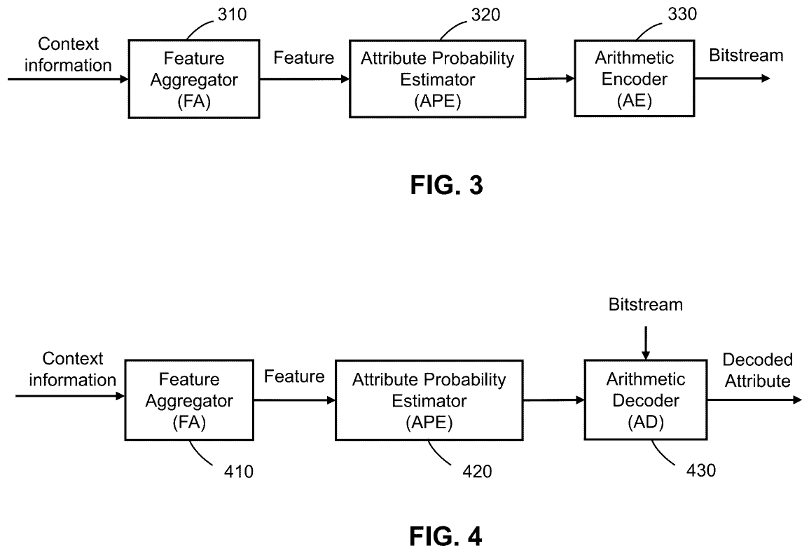

FIG. 3 and FIG. 4 illustrate an example of such top-down methods for octree-based attribute encoding and decoding, respectively. On the encoder side, the encoder conducts feature extraction/aggregation (310). A neural network model FA is deployed here for the feature extraction/aggregation. Its input is composed of at least the context information, for example, that indicates the attributes information of voxels in its parent level. Note that no information from finer level of details will be used. Different previous methods utilize different neural network models to do the feature extraction/aggregation.

The encoder estimates the attribute probability distribution of an octree voxel. This is achieved by another neural network model APE (attribute probability estimator, 320). The encoder performs arithmetic encoding AE (330) according to the actual attribute values of a current octree voxel based on the estimated probability.

On the decoder side, the decoder also performs feature aggregation (410) and attribute probability estimation (420) as the encoder. The corresponding arithmetic decoding AD is performed (430) to losslessly decode the attribute values of the corresponding octree voxel.

It should be noted here again that for attribute coding the geometry is already known for both the encoder and decoder, and only the attribute information is coded.

In this disclosure, we first propose a method that differs from the literature work when coding the octree-based attribute information for a point cloud in at least the following aspects:
1) The attribute probability distribution is estimated using finer level of details. It is a bottom-up strategy.
2) In the proposed encoder, before encoding attribute information into bitstream, attribute features are first encoded into bitstream that are extracted/aggregated based on the attribute information from the finer levels of the octree. Such features are used to assist the encoder to perform the arithmetic coding of the attribute information.
3) In the proposed decoder, it first decodes the feature, and then decodes the attribute information based on the decoded feature.

### Proposed Basic Encoding Method

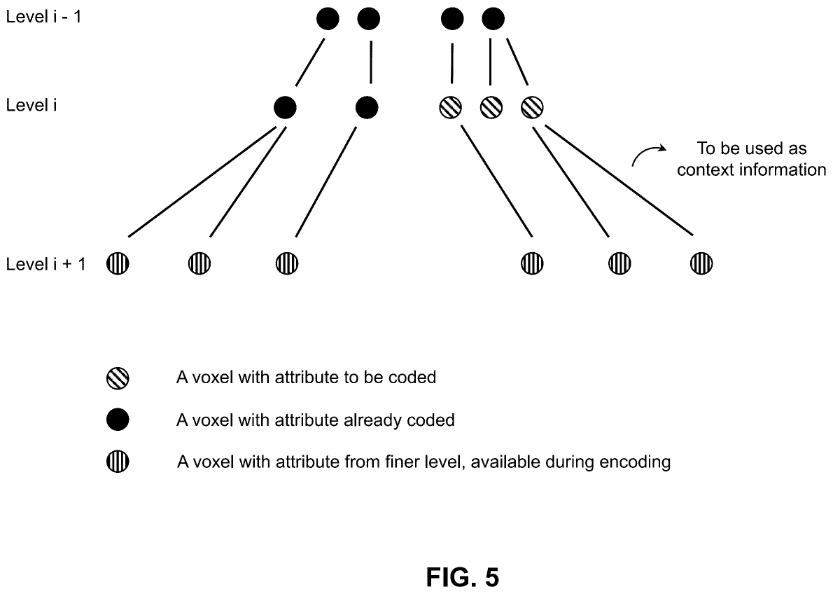

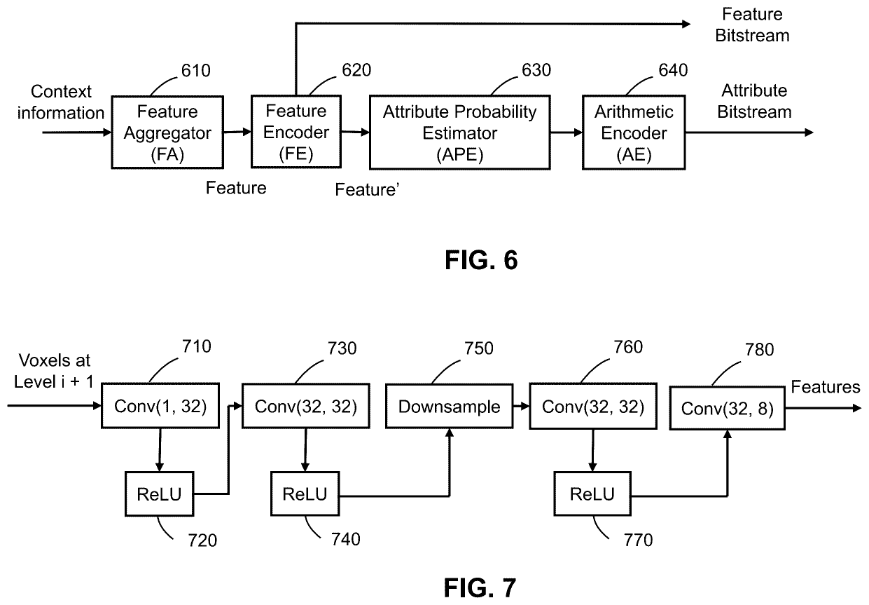

FIG. 5 illustrates a portion (level i−1, i, i+1) of the octree to be coded. FIG. 6 illustrates the proposed encoding method, according to an embodiment.

Unlike the feature extractor in prior-art method where the input is from its parent level and maybe from the current level in addition, the proposed feature extractor/aggregator (610) uses the finer (child) level of details as its input. Because the finer level of voxels always has more detailed information comparing to voxels from a parent level, it is much easier to extract more representative features.

The generated features are encoded (620) into bitstreams. In addition to generating the bitstream, the feature encoder also outputs the reconstructed feature (Feature′), that may not be exactly the same as the feature (Feature) from the feature extractor/aggregator (610). In one embodiment, the reconstructed feature is a quantized version of the feature from the feature extractor/aggregator (610). In one embodiment, a dequantization is further performed as the output of Feature Encoder. The reconstructed feature should match the decoded feature on a decoder.

The attribute probability estimator (APE, 630) uses a neural network model. It takes the reconstructed feature as its input and computes the attribute probability distribution of a current octree voxel.

Based on the estimated probability, the arithmetic encoder (640) will encode the attribute information of the current octree voxels into a bitstream.

In FIG. 6, feature bitstream and attribute bitstream are generated separately. In other implementations, one single bitstream can be generated to include both the feature and attribute information.

### Feature Aggregator

In one embodiment, the feature aggregator (FA) (610) is shown in FIG. 7. In this embodiment, the feature extractor just takes the immediate next level of voxel with attributes as input to extract features. No feature is propagated from earlier levels.

In this design of the feature aggregator (FA) (610), it is composed of several 3D convolutional layers (with downsample), i.e., the “Conv” blocks (710, 730, 760, 780), where Conv(x, y) means the input feature channel size is x while the output feature channel size is y. All the convolutional layers, except for the last one, are appended by a ReLU activation function (720, 740, 770) to introduce non-linearity to the feature aggregation process. The “Downsample” block (750) is to downsample the feature from (i+1)-th to the i-th level. In more advanced embodiments, the convolutional layers can be replaced with other commonly used feature aggregation blocks, such as an Inception ResNet (IRN) block, and a Voxel Transformer block, and these blocks can be repeated several times to enhance the feature aggregation performance.

The input to the FA module can be the voxelized point cloud with attribute information associated with it, for RGB color attribute, the input channel size can be 3; while for reflectance in LiDAR point cloud, the input channel size can be 1.

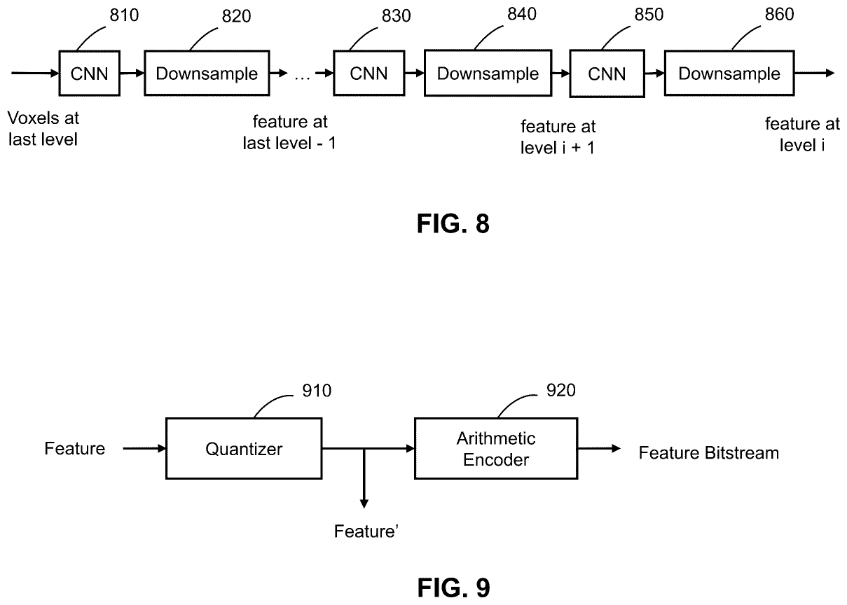

In another embodiment, the feature aggregator (FA) (610) is shown in FIG. 8. The feature extraction and aggregation start from the finest level of octree. Comparing to FIG. 7, the aggregated feature can be more powerful, as it undergoes a deeper network to aggregate the feature all the way from the finest level to the current level.

Specifically, in this design of the feature aggregator (FA) (610), it consists of several 3D convolutional neural network (CNN) blocks (810, 830, 850) followed by downsampling (820, 840, 860). The CNN module is simply composed of a series of back-to-back 3D convolutional layers. The “Downsample” blocks are to gradually downsample the feature from the last (finer) level to the i-th level. In more advanced embodiments, the CNN blocks can be replaced with other commonly used feature aggregation blocks, such as an Inception ResNet (IRN) block, or a Voxel Transformer block, and these blocks can be repeated several times to enhance the feature aggregation performance.

### Feature Encoder Using Uniform Quantization

The feature encoder (620) can be implemented in various ways. In one embodiment, a proposed feature encoder is shown in FIG. 9. The feature is quantized (910) based on a quantization step. The selection of quantization step is out of the scope of this work, but in a nutshell, it is a pre-selected parameter based on rate distortion requirement. The quantized feature is arithmetically encoded (920) into a feature bitstream. This proposed feature encoder is simple, and less complex comparing to the feature encoder described below.

### Feature Encoder Using Hyperprior Encoding

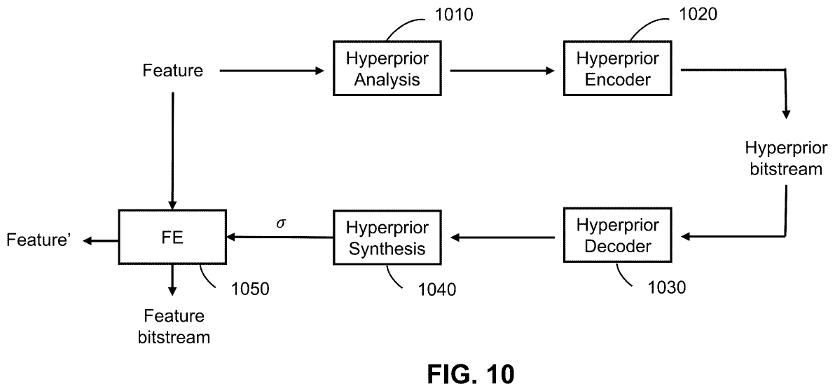

In this embodiment, another feature encoder (620) is proposed as shown in FIG. 10 which employs the hyperprior encoder. The purpose of this design is to analyze and utilize the distribution of the feature so as to perform efficient arithmetic coding of the feature.

The initial feature is sent to a “hyperprior analysis” module (1010) to aggregate a hyperprior feature that is more abstract than the input feature. The hyperprior feature needs much less bit rate to be encoded. It is used to compute the hyperprior parameters later. The hyperprior feature is encoded (1020) into a hyperprior bitstream, that may undergo some quantization first and then arithmetic encoding.

The hyperprior bitstream is arithmetically decoded (1030) to output a reconstructed hyperprior feature. In one embodiment, the reconstructed feature is dequantized further before being outputted. The reconstructed hyperprior feature is sent to a “hyperprior synthesis” module (1040) to compute the distribution parameters of the initial feature. In the embodiment shown in FIG. 10, the distribution parameters include variance parameters of the initial feature. In another embodiment, the distribution parameters include both the mean and the variance parameters of the initial feature.

The estimated hyperprior parameters (mean and variance) are provided to an arithmetic encoder (FE, 1050) to encode the initial feature. The hyperprior encoder is more advanced than the feature encoder illustrated in FIG. 9. It can provide higher coding performance. The “hyperprior analysis” (1010) and “hyperprior synthesis” modules (1040) are typically learnable neural network modules.

### Attribute Probability Estimator

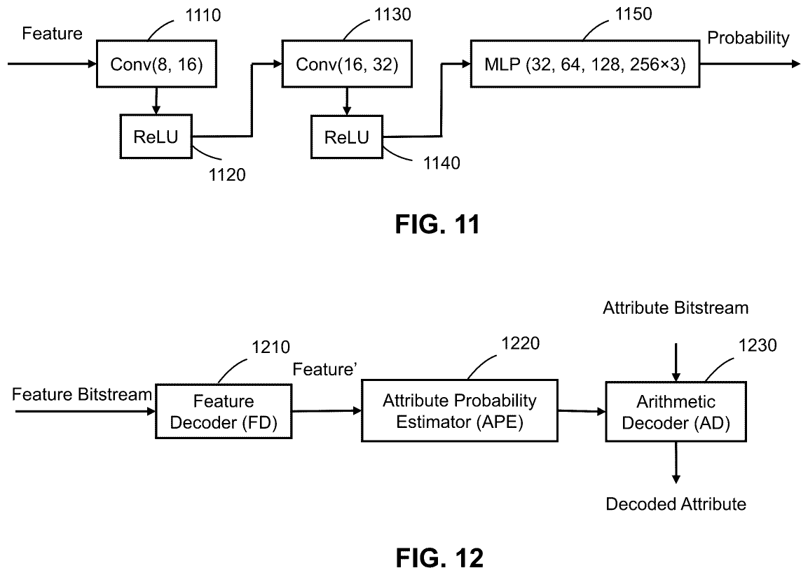

In this embodiment, a proposed attribute probability estimator (APE) (630) is shown in FIG. 11. Firstly, the feature map is further aggregated/refined by a few convolutional layers (two Conv layers, 1110, 1130), where a ReLU activation function (1120, 1140) is appended after each Conv layer to introduce non-linearity. After that, it is passed to a multilayer perceptron (MLP, 1150) to finally compute the probability. In FIG. 11, the parameters (32, 64, 128, 256×3) for MLP indicates the channel size of the MLP layers. In the end, the attribute probability distribution is a (256×3)-dimensional vector, which corresponds to probabilities of the value to be selected from [0, 255] for the 3 RGB channels. In the case of reflectance attribute for LiDAR point cloud, the MLP output can be a (100×1)-dimensional vector assuming there are 100 different reflectance intensities level to be considered.

### Proposed Decoding Method

FIG. 12 illustrates a proposed decoding method corresponding to the encoding method illustrated in FIG. 6, according to an embodiment. A feature decoder (FD, 1210) decodes a feature from the input bitstream. This is different from the previous method illustrated in FIG. 4, where the decoding starts with a feature aggregator. In the proposed decoder, it begins with a feature decoder (1210). Basically, the decoder relies on a coded feature rather than to extract the feature from scratch by itself. The proposed decoder benefits from a more representative feature as the features were extracted using finer level of details than from the parent level as in the previous method.

An attribute probability estimator (APE, 1220), which is the same as the APE (630) in FIG. 6, computes an attribute probability of a next octree voxel. Based on the estimated probability, the arithmetic decoder (AD, 1230) will determine the attribute values of the next octree voxel.

### Feature Decoder Using Uniform Quantization

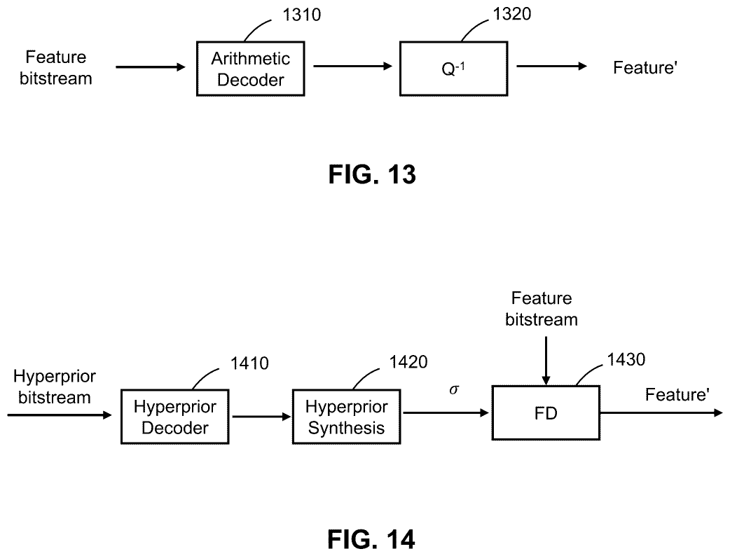

In this embodiment, a proposed feature decoder (1210) is shown in FIG. 13. This is the corresponding decoding of the encoder as shown in FIG. 9. Specifically, the input bitstream is arithmetically decoded (1310). Next, a dequantization step (1320) is conducted to output the decoded features. Note in another embodiment, the dequantization step (1320) is bypassed.

### Feature Decoder Using Hyperprior Decoding

In this embodiment, a proposed feature decoder (1210) is shown in FIG. 14. This decoder corresponds to the encoder as shown in FIG. 10.

In particular, the coded hyperprior feature is arithmetically decoded (1410) from a bitstream. The hyperprior feature is sent to a “hyperprior synthesis” module (1420) to generate the distribution parameters. In the embodiment shown in FIG. 14, the distribution parameters include the variance. In another embodiment, the distribution parameters include both the mean and the variance parameters. The features coded in a bitstream are arithmetically decoded (1430) based on the estimated hyperprior parameters.

Note that the “hyperprior synthesis” (1420) and “hyperprior decoder” (1410) are the same as the models (1040) and (1030) in FIG. 10. The “FD” (1430) is the arithmetic decoder of feature that corresponds to the “FE” the arithmetic encoder (1050) of feature in FIG. 10.

### Proposed Tree-Based Attribute Coding in a Full Compression Framework

In the above, the principles of proposed octree-based attribute encoding and decoding method are presented. In the follows, we describe how the proposed octree-based attribute encoding and decoding are designed within a larger full compression framework.

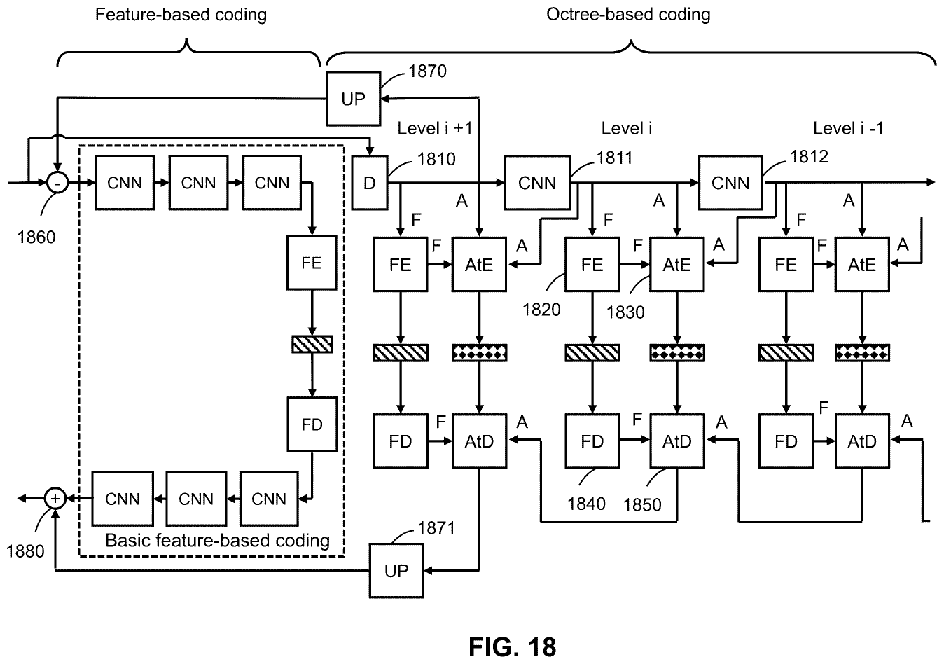

In the proposed overall lossy point cloud attribute compression framework, the octree-based attribute coding is used to code the coarser level of point clouds (i.e., point cloud octree partitions) that requires lossless coding for an exact reconstruction. In one embodiment, the proposed octree-based attribute coding is concatenated with a feature-based coding method. It leads to an overall lossy compression solution, as shown in FIG. 18 to FIG. 23.

In another embodiment, when the proposed octree-based attribute coding method is applied to code all octree levels, it leads to a full lossless compression solution. They are shown as in FIG. 18 to FIG. 23 with the “feature-based” coding being removed and only keeping the “octree-based coding” portion.

### Feature-Based Coding in the Overall Lossy Compression Framework

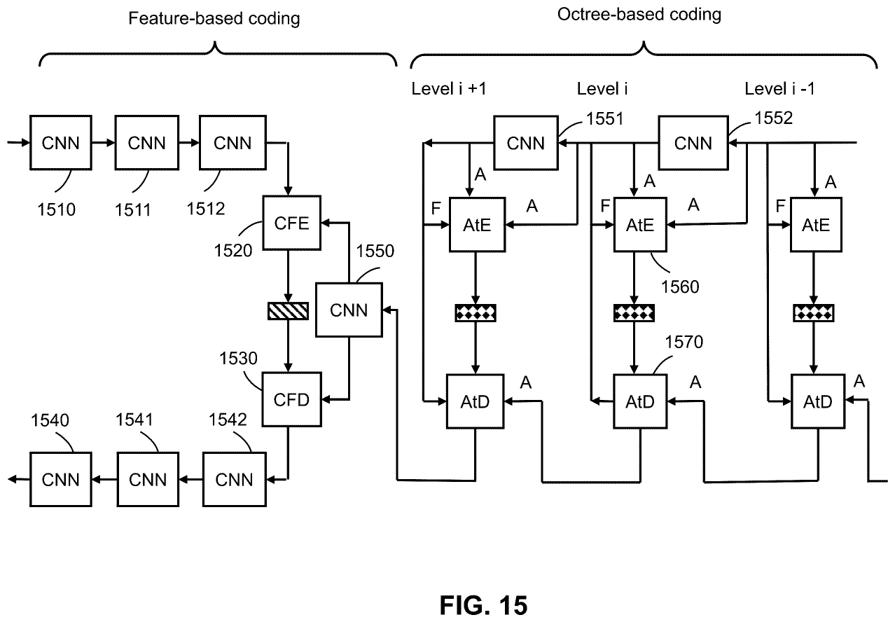

In the follows, we briefly describe the feature-based coding block as shown on the left of FIG. 15. The encoder is shown in the top part of the figure. It has a few CNN-like neural network modules (1510, 1511, 1512). They basically extract and aggregate a feature map from the input, for example, point cloud frames. During the feature extraction and aggregation, the resolution of the input is typically downsampled via pooling operations as part of the CNN-like neural network modules. Finally, the extracted feature is sent to a “Feature Encoder” (FE, 1520) module to output a bitstream. Note that the extracted feature represents the input point cloud attributes. To perform the feature aggregations (1510, 1511, 1512) and the “Feature Encoder” (FE, 1520), the features at each resolution are associated with a corresponding point cloud geometry that are previously encoded.

The decoder is shown in the bottom part of the figure. The feature is decoded by a “Feature Decoder” (FD, 1530) module from a bitstream. It has a few CNN-like neural network modules (1540, 1541, 1542). They correspond to the few CNN-like neural network modules (with downsampling) in the encoder. Instead of performing downsampling/pooling, the CNN-like neural network modules reconstruct the input, e.g., point cloud, via upsampling/unpooling. The CNN modules can be enhanced or replaced by MLP or some other neural network modules, such as the Inception ResNet (IRN) or Transformer blocks.

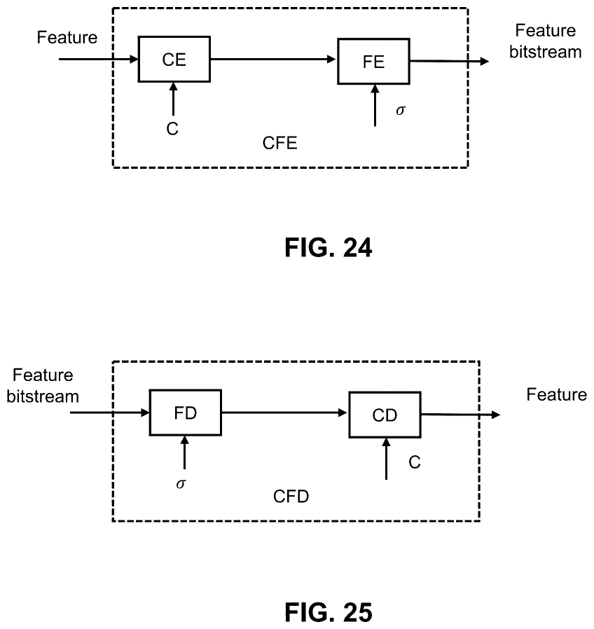

It should also be noted that both the “Feature Encoder” (FE, 1520) and the “Feature Decoder” (FE, 1530) are conditional in nature and encode/decode the current feature based on a feature made from the lossless attribute reconstruction from the finest level lossless attribute decoder via the CNN-like neural network module (1550). The detailed architecture of the conditional coders will be explained later and is depicted in FIG. 24 and FIG. 25.

### Full Compression Framework (Traditional)

We first describe a previous octree-based attribute compression method for lossless coding as shown in the full compression framework in FIG. 15. In this figure, we show how the elementary encoding and decoding modules are concatenated. This example serves as a background for the design of the next few embodiments which utilize our proposal.

In the top of the figure, we show three CNN-like neural network modules (1551, 1552) being concatenated to do feature extraction and/or aggregation. Note that the direction of the flow from right to left indicates that in prior-art octree coding methods, that is, the features are extracted from parent octree levels (and/or voxels already decoded in the current octree level). Each CNN represents a neural network module to generate/aggregate a feature map that is associated with a point cloud with attributes at a certain resolution. The CNN module is shared between encoder and decoder. This CNN module corresponds to the feature extraction/aggregation FA module in FIG. 3.

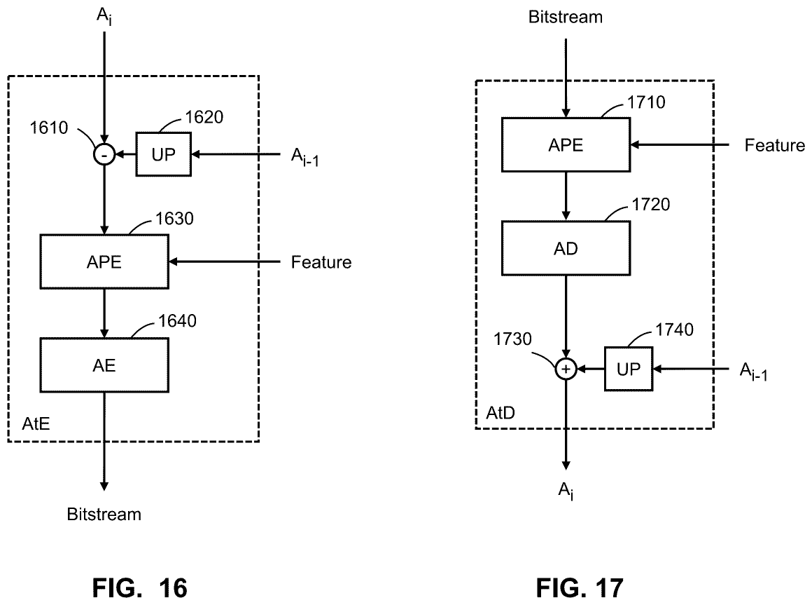

When encoding the point cloud with attributes at level i, the encoder will take the point cloud with attributes at level i and level i−1 as input. The point cloud with attributes at level i−1 is upsampled (1620) and only its residual (1610) with the point cloud with attributes at level i is to be encoded using module AtE (attribute encoder, 1560). Module AtE corresponds to blocks APE (1630) and AE (1640) in FIG. 3, with details shown in FIG. 16. The feature output from the CNN is also provided to APE within AtE to assist the encoding, and “A” denotes the attribute information and “F” denotes a feature map.

When decoding the point cloud attributes at level i, the decoder will take the point cloud with attributes at level i−1 and the coded octree bitstream as input. The decoding is fulfilled via module AtD (1570). Module AtD corresponds to block APE (1710) and AD (1720) in FIG. 4, with details in FIG. 17. The decoded residual from the bitstream is added (1730) to the upsampled (1740) point cloud with attributes at level i−1.

It should be noted here that upsampling can be achieved in several ways. In one embodiment the upsampling can be a traditional module with nearest neighbor or repeat based upsampling. In another embodiment, the upsampling can be a learning-based module based on CNN, ResNet, IRN or Transformer architectures. Additionally, since the geometry is assumed to be known at all levels during attribute coding, the upsampling has embedded pruning to match the geometry at level i.

### Full Compression Framework, Embodiment 1

In this embodiment, a proposed octree-based attribute coding is in use. FIG. 18 illustrates how the proposed octree-based elementary attribute coding blocks are concatenated according to this embodiment. We could see some blocks and connections are shared between FIG. 15 and FIG. 18. The differences are presented as follows.

First the few CNNs (1811, 1812) in the top are now only used during encoding and they consecutively downsample the point cloud, unlike in FIG. 15 where they are used in both encoding and decoding with upsampling. This is a result that in the proposed octree-based attribute coding, the features extracted by the CNNs are encoded into bitstreams. In earlier methods, they are not coded. Instead, the decoder runs the same feature extraction as the encoder. This is reflected by the feature encoding module FE (1820) in FIG. 18. On decoder side, the feature is decoded by module FD (1840). The decoded feature is used to assist the octree-based attribute encoding AtE (1830) and octree-based attribute decoding AtD modules (1850). Note that for ease of notations, we use F to denote both the extracted feature and the decoded/reconstructed feature.

Also note that the direction to perform feature extraction by CNNs is now from left to right. It indicates that the feature extraction is based on a finer level of octree. Note all voxels in the current level may also be used since the encoder has access to the whole octree. For the earlier methods that don't transmit feature bitstream, they cannot use any voxel not yet encoded/decoded for feature extraction. One thing to note is that the input to the finest level of octree-based coding is directly the input point cloud with attributes appropriately downsampled (1810) to the current resolution.

Another difference is in the feature-based coding in FIG. 18. Firstly, the feature encoder and decoder are simple and not conditional in nature as shown in FIG. 15. Instead of extracting and encoding features based directly on the input point cloud with attributes, in the proposed framework the feature is extracted from the residual (1860) between the input and the (naively) upsampled (1870) lossless reconstruction from the parent level.

The decoded attribute values are considered as residuals and are added (1880) on top of the upsampled (1871) lossless reconstruction from the parent level.

The module that performs feature-based coding in FIG. 18 is hereby denoted as basic feature-based coding, which will be re-used in our proposed work as described further below.

### Full Compression Framework, Embodiment 2

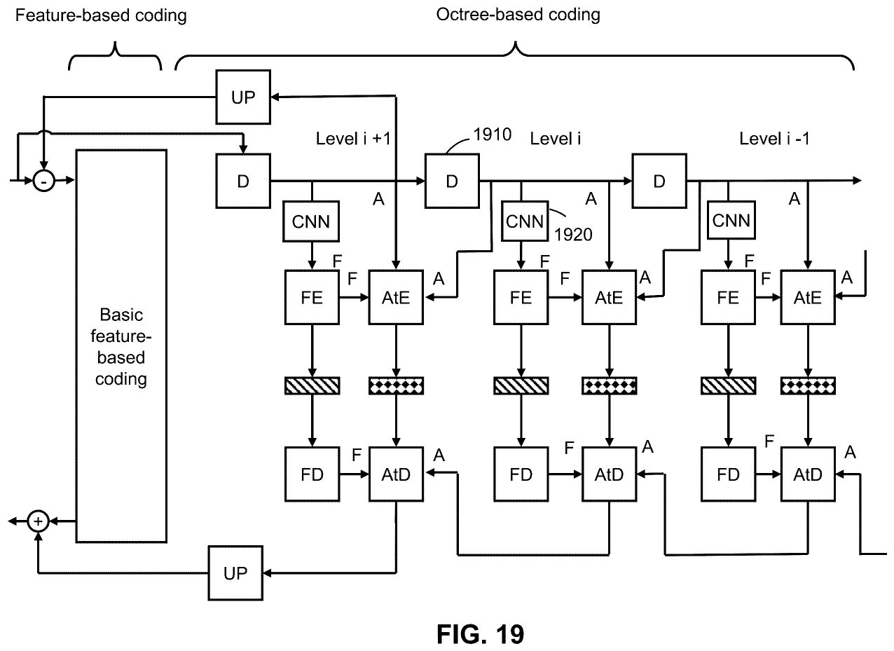

In this embodiment, the framework in FIG. 18 is updated as in FIG. 19. The update is on the encoder side. The CNNs (feature aggregation) is simplified by downsampling modules. The CNNs typically have both feature extraction and pooling (downsampling) steps. In this design, it is proposed to simplify the process by only keeping the downsampling (1910).

The motivation of the simplification is to cut the path for feature aggregation/propagation from a finer resolution. Instead, the features are always extracted solely based on the point cloud attributes at the current resolution, e.g., level i.

A new CNN (1920) is inserted right before the Feature Encoding FE module. The new CNN at resolution i in FIG. 19 takes the point cloud attributes at resolution i as input, and then generates features to help the octree-based attribute coding. This is different from the CNN in FIG. 18 where the input to the CNN at resolution i is the point cloud at resolution i+1.

### Full Compression Framework, Embodiment 3

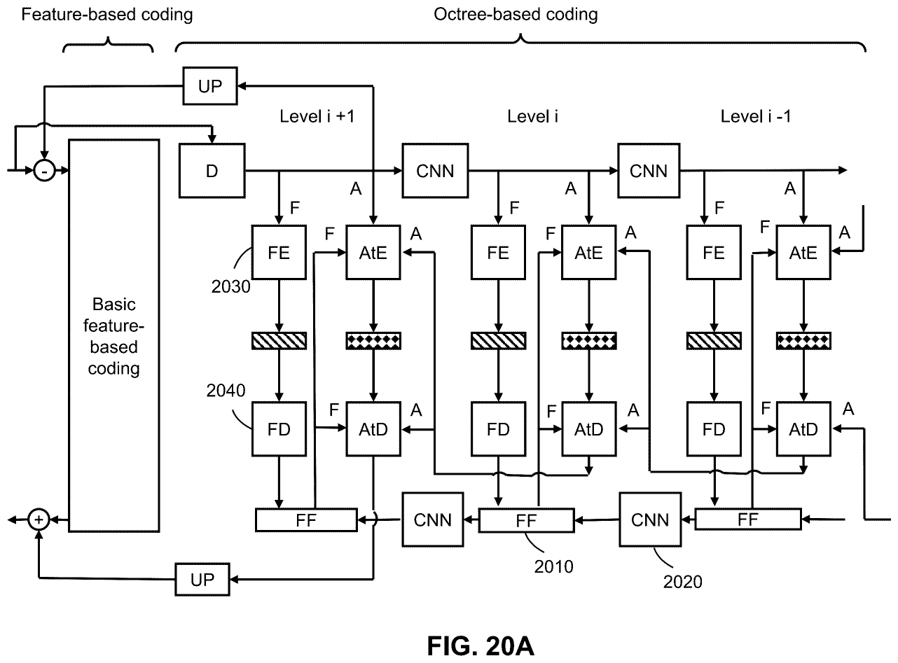

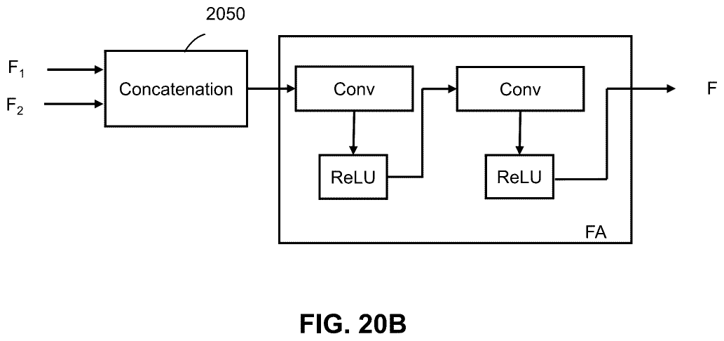

In this embodiment, the framework in FIG. 18 is updated as in FIG. 20A. The update is on the decoding stage. The new embodiment is motivated by having a stronger feature to assist the octree-based attribute encoding and decoding.

In FIG. 18, the feature in use is just the feature extracted from encoding pipeline. In this embodiment (FIG. 20A), the feature extracted/encoded/decoded is treated as a residual information. It is not directly used to assist octree-based attribute encoding and decoding.

Instead, the decoder introduces a feature aggregation pipeline, that starts from the root level (from the right side of the figure). Just like CNNs in feature-based decoding, the CNNs (2020) are to perform feature aggregation and unpooling (upsampling).

At a given level, e.g., level i, the aggregated feature of the CNN is to be enhanced by the feature decoded from the bitstream in a Feature Fusion FF module (2010). The two features are to be fused and enhanced. Basically, the FF module, as shown in FIG. 20B, first concatenates (2050) the two input features, followed by applying an FA block to enhance the fused feature. The outputted feature from FF module is finally sent to octree-based attribute encoding or decoding modules. In this sense, the feature decoded from the bitstream serves as a residual/supplement to further improve the aggregated feature of the CNN. Then the enhanced feature is used to assist the octree-based attribute encoding (AtE) and decoding (AtD).

### Full Compression Framework, Embodiment 4

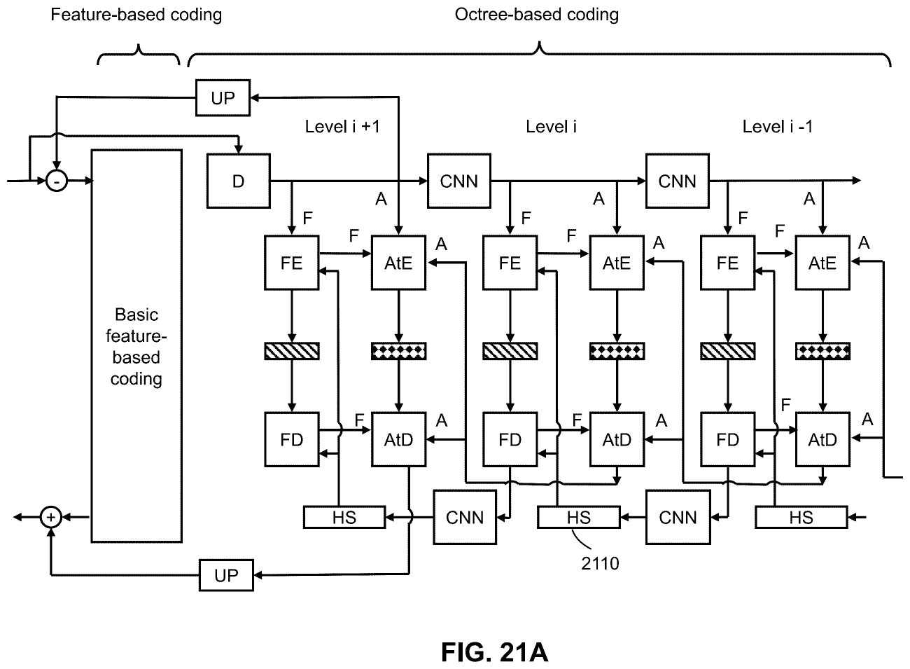

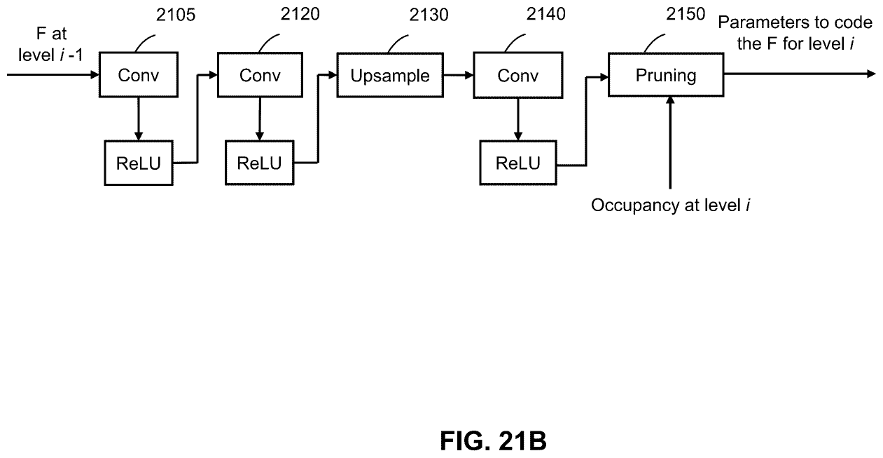

In this embodiment, the framework in FIG. 20A is updated as in FIG. 21A. The update is on the decoding stage. The new embodiment is motivated by using a different way to benefit the coding performance.

In the new embodiment, the block FF in FIG. 20A is replaced by HS block (2110) in FIG. 21A. The new hyper synthesis HS block (2110) takes the output of CNN block as input and outputs a set of estimated hyperprior parameters that is sent to feature encoding block FE and feature decoding block FD. Then the features reconstructed from feature encoding and decoding blocks are used to assist the attribute encoding block AtE and decoding block AtD. The output from AtD block is the final reconstruction of point cloud with attributes at the current resolution.

FIG. 21B shows an example diagram how the HS block is implemented. It performs some initial feature aggregation via convolutions (2105, 2120) upon an input feature at level i−1. Then the feature is upsampled (2130) to level i followed by additional convolution (2140). This additional convolution (2140) generates a set of hyperprior parameters. Finally, a pruning (2150) is performed to remove the hyperprior parameters on empty voxels since the geometry is previously encoded/decoded.

The motivation behind using HS is to use the coded information in bitstreams from coarser levels and estimate the hyperprior parameters of the features in current level. The idea is similar to the diagram described in FIG. 10 and FIG. 14, but the feature encoding and decoding do not rely on a hyperprior analysis/encoding/decoding as in FIG. 10 and FIG. 14. Instead, in this embodiment, a hierarchical hyperprior model is in use to assist the encoding and decoding of the features. This is called hierarchical in this context because hyperprior model is deployed for estimating the hyperprior parameters at each level.

It should be noted here that the encoding/decoding methods in FIG. 18, FIG. 19, FIG. 20, FIG. 21 can be swapped for additional embodiments.

### Full Compression Framework, Embodiment 5

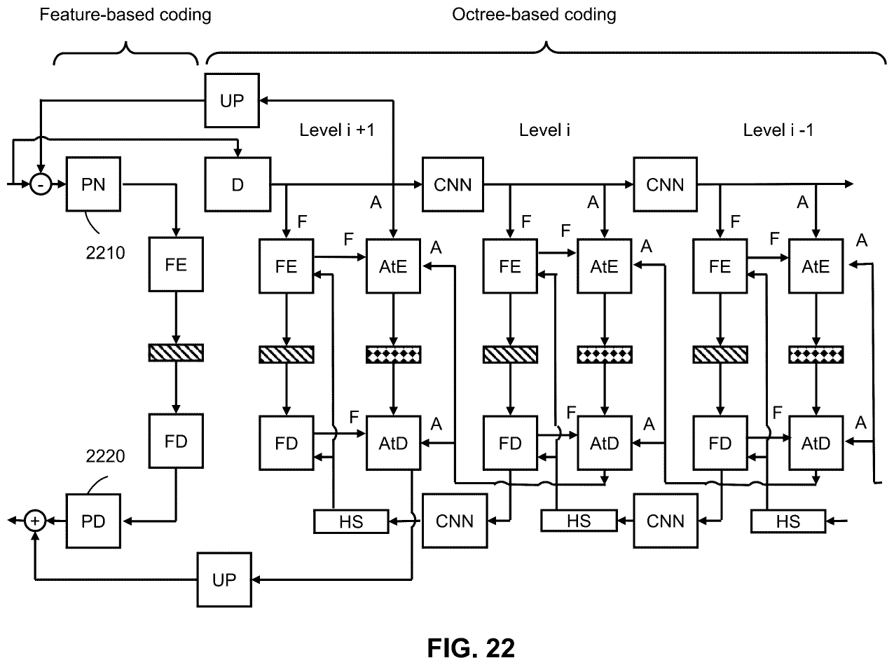

In this embodiment, the framework in FIG. 21A is updated as in FIG. 22. The convolution-based feature aggregation modules may not be suitable for sparse point clouds like LiDAR scans. Hence, the “basic feature-based coding” is proposed to be replaced by point-based networks. As an example, the well-known PointNet design (2210) can be used for feature extraction from a point cloud (with or without features attached to each point) on the encoder side. Advanced point-based architectures like Point Transformer can also be deployed for this purpose. The rest of the encoding mechanism stays the same.

Similarly, on the decoder side, instead of using convolutions, a point-based network (2220) can directly output the predicted attributes (instead of probability distributions) based on the decoded features. In one embodiment, this can be achieved using a simple Latent GAN design which simply consists of a series of MLP layers. It can also be replaced by any other point-based decoder for point cloud generation, for example, FoldingNet decoder, TearingNet decoder.

### Unified Feature-Based Coding and Octree-Based Coding

In this embodiment, we further extend the idea proposed for octree-based attribute coding to feature-based attribute coding. This leads to a unified coding framework where the feature-based attribute coding and octree-based attribute coding share the same backbones to code the features.

We take the octree-based attribute encoding method shown in FIG. 19 and decoding method in FIG. 21A as an example how the feature coding method introduced in octree coding can be extended to feature-based attribute coding pipeline. The other octree-based attribute coding methods proposed in this work, e.g., FIG. 18, FIG. 19, FIG. 20 and FIG. 21 can also be extended to feature based attribute coding in a similar manner.

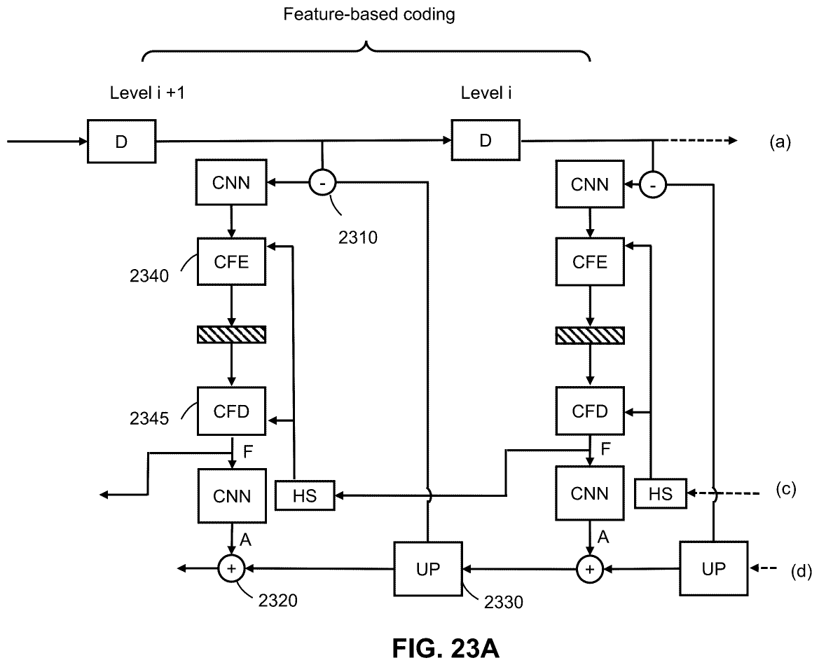

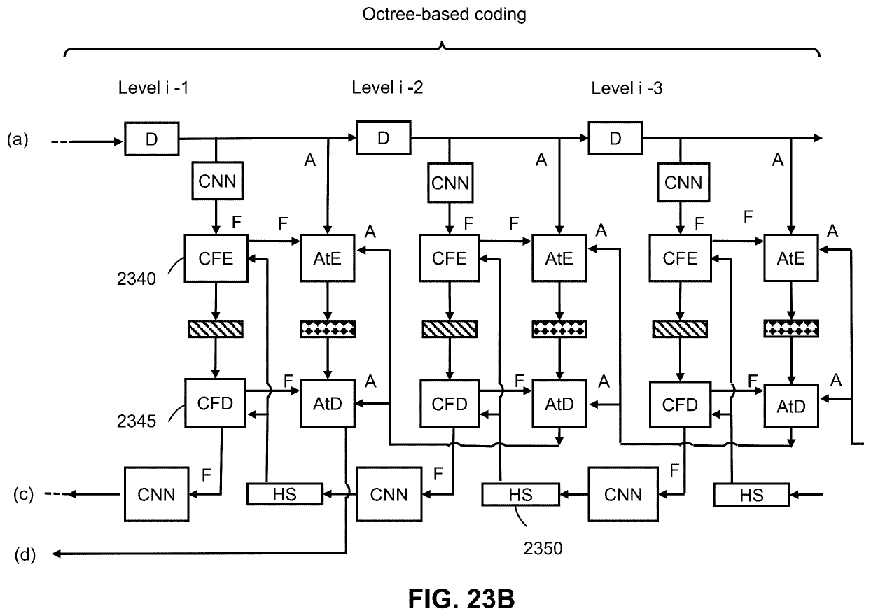

FIG. 23A and FIG. 23B illustrate the feature-based and octree-based attribute coding respectively in the proposed unified framework. The feature-based attribute coding pipeline FIG. 23A is now enhanced using a proposed method. The octree-based attribute coding pipeline FIG. 23B is taken from the earlier proposed methods in this work. The decoding in FIG. 23B is modified based on FIG. 21A.

Traditional feature-based attribute coding typically just encodes the feature at the bottleneck layer into one bitstream as shown in FIG. 19, as well as FIG. 15, FIG. 18, FIG. 20, and FIG. 21.

In the proposed embodiment in FIG. 23A, the bottleneck level separating feature-based attribute coding and octree-based attribute coding is level i, with level i belonging to feature-based attribute coding In addition to the single bitstream encoded at the bottleneck level with “Basic feature-based coding” (as FIG. 15, FIG. 18, FIG. 19, FIG. 20, and FIG. 21), additional bitstreams for the other levels are further encoded, for example, level i+1, etc.

During the encoding of features in each level of feature-based attribute coding pipeline (starting from i) in FIG. 23A, the conditional feature encoding CFE and conditional feature decoding CFD are assisted by the HS block at the same level in a similar way as presented in the diagram for octree-based coding in FIG. 21. The input to the HS block is the output of the CFD from the previous layer (level). The HS block then outputs a set of hyperprior parameters for the feature to be coded at the current layer. The set of hyperprior parameters output by HS are provided as an input to the FE inside the CFE (FIG. 24) and provided as an input to the FD inside the CFD (FIG. 25). The set of hyperprior parameter can benefit the coding of the features in current layer.

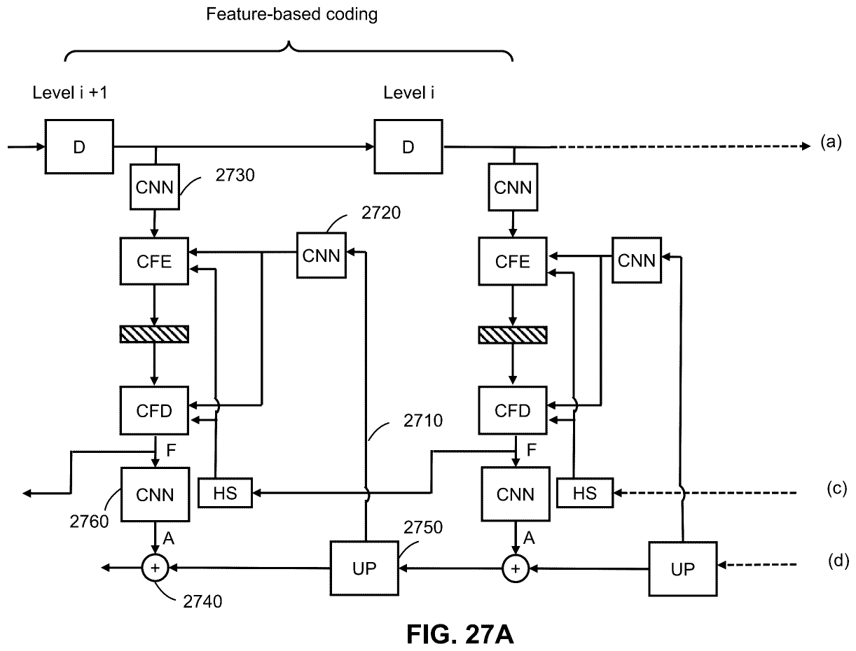

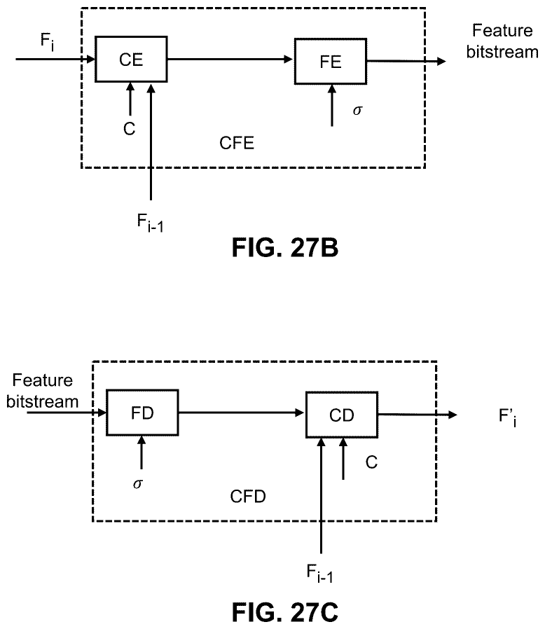

The proposed feature-based attribute coding in FIG. 15 to FIG. 21 only encodes the residual between the input point cloud with attributes and the lossless reconstruction from the parent level. However, to enable the hierarchical feature-based attribute coding, at the encoder side multiple residuals (2310) are encoded in one embodiment between the point cloud with attributes at current resolution and the upsampled lossy/lossless reconstruction from the respective parent levels, as shown in FIG. 23A. On the decoder side, the same residuals are added (2320) to the same upsampled (2330) lossy/lossless reconstructions from the respective parent levels for final reconstruction. This leads to a symmetric design between encoder and decoder comparing to an asymmetric design in FIG. 27 to be presented later.

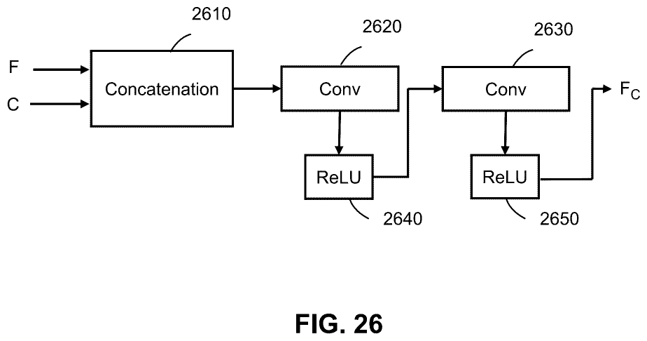

Another major difference of FIG. 23A/FIG. 23B from the previous figures depicting overall architecture is that the FE and FD are replaced respectively by CFE (2340) and CFD (2345), as shown in detail in FIG. 24 and FIG. 25, respectively. The same CFE/CFD apply to both FIG. 23A and FIG. 23B in one embodiment. The CFE (conditional feature encoder) and CFD (conditional feature decoder) are the FE (2030) and FD (2040) but perform an additional conditional encoder (CE) and conditional decoder (CD) with an additional input conditional feature (C), respectively. The CE and CD follow exactly the same architecture as shown in FIG. 26. The two input features to CE/CD, F (feature to be encoded or decoded feature) and C (context/conditional feature), get concatenated (2610) first. Then the feature mixing is conducted via a few convolutional layers (2620, 2630) to output the updated feature.

We can now compare FIG. 23A/B to FIG. 20A. Architectures in both figures have the same motivation to improve coding efficiency. That is, to further reduce the redundancy in the feature to be coded by taking the already known conditions/information into account. This technology is generally called conditional coding. Though sharing the same motivation (between FIG. 23A/B and FIG. 20A), in FIG. 20A the conditional coding is being performed to update the input feature to octree coding modules AtE/AtD whereas in FIG. 23A/B the conditional coding is being performed within feature coding modules CFE/CFD. Both of these architectures are different embodiments of utilizing the same overall motivation of conditional coding.

In one embodiment, the conditional feature (C) can be a feature extracted from the reconstructed attributes of the previous levels.

In yet another embodiment as shown in FIG. 27A, the residual connection (2310) to the CNN at the top (encoder side) is removed. That is, the feature extraction is performed from the full values of attributes instead of residual values from a parent level as in FIG. 23A. Additionally, the upsampled feature (2710) from previous (decoded) attributes is aggregated through CNN (2720, sharing same parameters as the top CNN, 2730) and provided as additional input to CFE and CDE. In the figure, this is only shown for the feature-based coding, but the same conditional input can be applied to octree-based coding as well (not shown for simplicity of diagram). This leads to an asymmetric design between encoder and decoder. In case of octree-based coding, the residual connection (1610, 1730) in AtE/AtD is removed as one embodiment.

The details of the updated CFE and CFD with the additional input are shown in FIG. 27B and FIG. 27C, respectively. The additional input is made available to the CE and CD modules within CFE and CFD, respectively. The motivation of the additional input based on the features from the previous (decoded) attributes to both CFE and CFD is to reduce redundancy in the encoded feature by only encoding the information relevant to the current level.

In another embodiment, the residual connection (2740) from the upsampling module (2750) is removed. The attribute output from CNN (2760) is outputted to the next level.

In another embodiment, the unified architecture can have a combination of the hierarchical and non-hierarchical feature-based attribute coding. The feature-based attribute coding shown in FIG. 23A and FIG. 27 has a hierarchical structure where at every level a feature bitstream is coded and transmitted. With this design, the intention is first code as much as possible information at coarser level bitstream with lower resolutions, then the bitstream from a finer level is to enhance the reconstruction. In this embodiment, the hierarchical coding can be used to code several intermediate levels followed by non-hierarchical coding for the last few levels. With non-hierarchical coding for the last few levels, there is no bitstream for every level rather than a single bitstream for all the few levels specified. Such combination of hierarchical and non-hierarchical coding can help to further reduce the overall bitrate consumption specially when the data is noisy. For noisy data, the high frequency information lives mainly on the last few levels and thus a single non-hierarchical bitstream for coding the last few levels can be sufficient.

### Style Control

Our proposal can be combined with our earlier work ('987 application), to achieve a network model that can perform finer-grain rate control. Under the same rationale, it can be extended to support more advanced functionalities, such as supporting both inter coding and inter coding using the same set of model parameters. We call this embodiment the style control because it enables the codec to work under different desired styles/conditions.

### Style Encoding and Adaptive Affine

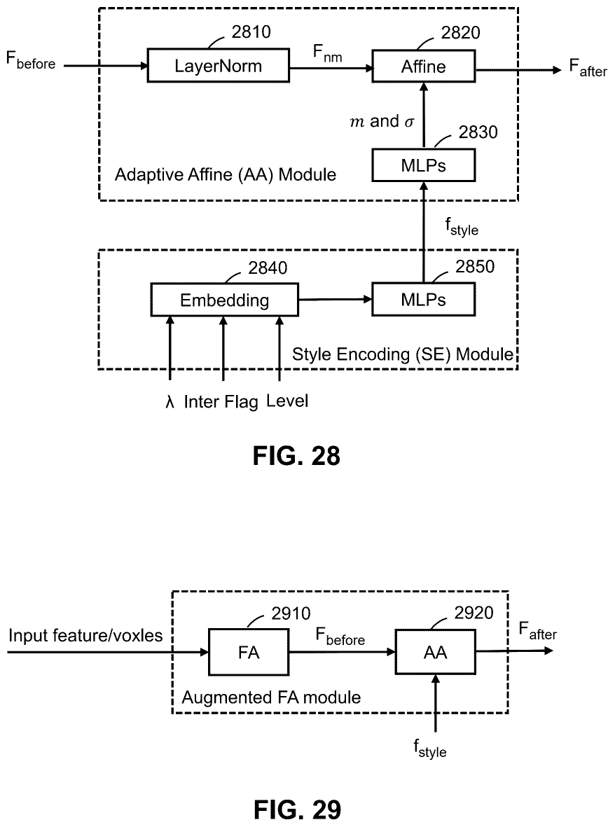

The key to this embodiment is the adaptive affine (AA) module, discussed in the '987 application, and also provided at the top of FIG. 28. In this embodiment, the AA module works together with another module that we call the style encoding module (SE), as shown at the bottom of FIG. 28.

The SE modules may take several different inputs. It can be computed only once during the whole encoding or during the whole decoding period. When finer-rate control with a set of single network parameters is needed, the R-D tradeoff parameter λ chosen by the user need to be provided as an input to SE. Here a smaller lambda corresponds to a higher-quality decoded point cloud but a higher bitrate, and vice versa.

The number of the current octree level being encoded/decoded can also be optionally passed to the SE module; in this case, the SE module needs to be launched per-level rather than just one time during encoding/decoding because every different octree level will have a different input to SE.

The SE module uses an embedding module (2840) to compute an embedding for the inputs, where the embedding module can have different designs, e.g., the (sinusoidal) positional embedding used in the transformer literature, or simply concatenates the original input. In an embodiment, the embedding module may apply positional embedding to λ, then concatenate with the binary inter flag and the number of the current level to obtain a raw representation of the style. After that, a few MLP layers (2850) are appended to output a feature vector that we call the style feature f_{style}. Again, note that when the current level is included, the SE module needs to be computed per-level because every level has a different style feature vector f_{style}.

Next, the style feature will be fed to the adaptive affine (AA) module described in the '987 application, which is to adaptively process an input feature map F_{before}, and output the processed/affined feature F_{after}. The AA module first applies a layer normalization (2810) to the input leading to the normalized feature Fₙₘ, then with the input f_{style}, it computes a new mean m and variance σ with a few MLP layers (2830). Then an affine module (2820) is applied to the normalized feature Fₙₘ via scaling and shifting, so that it output a feature F_{after} with mean m and variance σ.

### Style Control With Adaptive Affine Modules

To apply the style control, at least a module on the encoder and at least a module in the decoder need to be augmented by an AA module. FIG. 29 shows an example of augmenting the FA module (2910) with the AA module (2920), which simply appends an AA module after the FA module. The augmented FA module takes not only takes its original input but also additionally f_{style} associated to it as the input. When the octree level, e.g., level i, is used to compute f_{style}, then this f_{style} is used to feed to all the AA modules operating at the octree level i. In another embodiment, the AA module may also be applied before the FA module to form the augmented FA module. In the same manner, other modules described in our work can be augmented by the AA module.

We note that with this embodiment, it is possible to achieve rate control for individual octree level by providing different desired λ parameters to different levels. In one embodiment when constructing a full point cloud coding system, we can set a particular λ parameter to the octree coding part (FIG. 15) and set another λ parameter to the feature-coding part (FIG. 15) so as to have flexible rate control of the feature between lossy and lossless coding.

### Parameter Sharing

In the design of FIG. 15, and FIG. 18 through FIG. 23, the CNN blocks on the encoder side may have similar architectures, and the CNN blocks on the decoder side may also have similar architectures. Such similarity of network architecture motivates us to propose the following:
1) Let all the CNN blocks on the encoder side to share the same set of network parameters;
2) Let all the CNN blocks on the decoder side to share the same set of network parameters.

Without the proposed model sharing, the feature-based coding and octree-based coding needs two sets of separate neural networks parameters. It not only makes the overall parameter size larger but also requires retraining and reloading of the neural network parameters when the bottleneck level separating feature-based coding and octree-based coding is changed.

With this proposed embodiment, the feature-based (lossy) coding and octree-based (lossless) coding are additionally unified under the same set of encoder and decoder CNN pairs. During inference, the codec can be reconfigurable while maintaining the conformance/compatibility using the same set of neural network parameters.

The CNN modules presented in the designs are just for example. Advanced neural network architectures can be applied without changing the intended technologies. Additionally, the proposed method applies to other tree-based coding other than octree coding alone.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding point cloud data according to the methods described above.

One or more embodiments provide a computer readable storage medium having stored thereon point cloud data generated according to the methods described above. One or more embodiments also provide a method and apparatus for transmitting or receiving point cloud data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A method of decoding point cloud data, comprising:
decoding features representing voxel attributes in an octree structure, wherein a decoded feature for a current voxel is representative of at least a set of voxels that are still to be reconstructed;
determining an attribute probability of the current voxel based on the decoded feature for the current voxel;
decoding attribute information of voxels in the octree structure, wherein the attribute information for the current voxel is decoded based on the attribute probability for the current voxel; and
reconstructing the point cloud based on the attribute information of voxels in the octree structure.

2. The method of claim 1, further comprising:
obtaining another feature for the current voxel from one or more coarser levels; and
generating a first feature based on the another feature and the decoded feature of the current voxel, wherein the attribute information of the current voxel is decoded based on the first feature.

3. The method of claim 1, further comprising:
obtaining hyperprior parameters of the features in a current level of the octree structure based on one or more coarser levels, wherein the features of the current level are decoded based on the hyperprior parameters.

4. The method of claim 3, wherein the obtaining hyperprior parameters of the features in a current level of the octree structure comprises:
obtaining a second feature from the one or more coarser levels;
obtaining a third feature at a resolution of the current level, using at least a neural network with upsampling;
obtaining an initial set of hyperprior parameters based on the third feature using at least another neural network;
obtaining voxel occupancy information at the current level; and
pruning any hyperprior parameters at empty voxels indicated by the voxel occupancy information to form the hyperprior parameters.

5. The method of claim 1, further comprising:
augmenting the feature based on a parameter controlling a tradeoff between a bit rate and quality.

6. The method of claim 1, wherein a coarser portion of the point cloud data is decoded losslessly and a finer portion is decoded by lossy compression, the lossy compression comprising:
decoding first attribute information for the finer portion;
upsampling second attribute information from the coarser portion; and
generating third attribute information for the finer portion based on the first attribute information and the upsampled attribute information.

7. The method of claim 6, wherein the first attribute information includes a difference feature indicating a difference between the upsampled reconstruction of the previous level and the current level of the point cloud, wherein a convolutional layer is applied to the difference feature, and wherein the second attribute information includes a reconstruction of a previous level of the point cloud.

8. The method of claim 6, further comprising:
upsampling a reconstruction of a previous level of the point cloud, wherein convolutional layers are applied to the upsampled reconstruction of the previous level.

9. The method of claim 6, wherein the lossy compression is based on a feature-based attribute coding pipeline and the lossless compression is based on an octree-based attribute coding pipeline, and wherein the feature-based attribute coding pipeline and the octree-based attribute coding pipeline share a same backbone to decode features.

10. A method of encoding point cloud data, comprising:
obtaining features representing voxel attributes in an octree structure, wherein feature for a current voxel is representative of at least a set of voxels that are still to be encoded;
encoding the feature;
determining an attribute probability of the current voxel based on the feature; and
encoding attribute information of voxels in the octree structure, wherein the attribute information for the current voxel is encoded based on the attribute probability for the current voxel.

11. The method of claim 10, further comprising:
obtaining another feature for the current voxel from one or more coarser levels; and
generating a first feature based on the another feature and the feature of the current voxel, wherein the attribute information of the current voxel is encoded based on the first feature.

12. The method of claim 10, further comprising:
obtaining hyperprior parameters of the features in a current level of the octree structure based on one or more coarser levels, wherein the features of the current voxel are encoded based on the hyperprior parameters.

13. The method of claim 12, wherein the obtaining hyperprior parameters of the features in a current level of the octree structure comprises:
obtaining a second feature from the one or more coarser levels;
obtaining a third feature at a resolution of the current level, using at least a neural network with upsampling;
obtaining an initial set of hyperprior parameters based on the third feature using at least another neural network;
obtaining voxel occupancy information at the current level; and
pruning any hyperprior parameters at empty voxels indicated by the voxel occupancy information to form the hyperprior parameters.

14. The method of claim 10, wherein a coarser portion of the point cloud data is encoded losslessly and a finer portion is encoded by lossy compression, the lossy compression, comprising:
reconstructing the coarser portion of the point cloud;
obtaining point cloud at a current level; and
encoding features for the finer portion based on the point cloud at the current level and feature information from the coarser portion.

15. The method of claim 14, further comprising:
upsampling a reconstruction of a previous level of the point cloud;
obtaining a difference between the upsampled reconstruction of the previous level and the current level of the point cloud; and
generating a difference feature indicating the difference using a neural network, wherein the difference feature is encoded.

16. The method of claim 14, further comprising:
generating a first set of features representing voxel attributes in an octree structure, based on the point cloud at the current level;
upsampling a reconstruction of a previous level of the point cloud;
generating a second set of features based on the upsampled reconstruction; and
encoding the first set of features based on the second set of features.

17. An apparatus for decoding point cloud data, comprising one or more processors and at least one memory coupled to the one or more processors, wherein the one or more processors are configured to:
decode features representing voxel attributes in an octree structure, wherein a decoded feature for a current voxel is representative of at least a set of voxels that are still to be reconstructed;
determine an attribute probability of the current voxel based on the decoded feature for the current voxel;
decode attribute information of voxels in the octree structure, wherein the attribute information for the current voxel is decoded based on the attribute probability for the current voxel; and
reconstruct the point cloud based on the attribute information of voxels in the octree structure.

18. The apparatus of claim 17, wherein the one or more processors are further configured to:
obtain another feature for the current voxel from one or more coarser levels; and
generate a first feature based on the another feature and the decoded feature of the current voxel, wherein the attribute information of the current voxel is decoded based on the first feature.

19. An apparatus for encoding point cloud data, comprising one or more processors and at least one memory coupled to the one or more processors, wherein the one or more processors are configured to:
obtain features representing voxel attributes in an octree structure, wherein feature for a current voxel is representative of at least a set of voxels that are still to be encoded;
encode the feature;
determine an attribute probability of the current voxel based on the feature; and
encode attribute information of voxels in the octree structure, wherein the attribute information for the current voxel is encoded based on the attribute probability for the current voxel.

20. The apparatus of claim 19, wherein the one or more processors are further configured to:
obtain another feature for the current voxel from one or more coarser levels; and
generate a first feature based on the another feature and the feature of the current voxel, wherein the attribute information of the current voxel is encoded based on the first feature.
